(19) United States
(12) Patent Application Publication
(10) Pub. No.: US 2013/0076528 A1
(43) Pub. Date: Mar. 28, 2013

(54) HEALTH MONITORING SYSTEM UTILIZING SERVICE CONSUMPTION DATA

(71) Applicants: Fred Henry Boettner, Roanoke, VA (US); Eugene Filmore Kea, Boones Mill, VA (US)

(72) Inventors: Fred Henry Boettner, Roanoke, VA (US); Eugene Filmore Kea, Boones Mill, VA (US)

(73) Assignee: GENERAL ELECTRIC COMPANY, Schenectady, NY (US)

(21) Appl. No.: 13/246,452

(22) Filed: Sep. 27, 2011

(51) Int. Cl. G08C 15/06

(52) U.S. Cl. 340/870.02

(57) ABSTRACT

Systems for using metered services for health care monitoring are disclosed. In one embodiment, a health monitoring system for a service location includes: a utility meter communicatively connected to the service location; and at least one computing device communicatively connected to the utility meter, the at least one computing device adapted to monitor a health condition of an animal located at the service location by performing actions comprising: obtaining service consumption data about the service location from the utility meter; comparing the service consumption data with a pattern of service consumption for the service location; and determining a health condition of the animal based upon the comparison of the service consumption data with the pattern of service consumption for the service location.

### BACKGROUND OF THE INVENTION

The subject matter disclosed herein relates generally to meter technology, and more particularly, to tools for using metered services (e.g., utility services which are monitored by an electrical meter, a water meter, a gas meter, a network of electrical meters, a smart meter, etc.) for health care monitoring.

Some health care providers and assisted living services, have begun to offer and/or use health monitoring systems to track and monitor the health condition of certain animals (e.g., human beings, patients, persons, etc.). These animals having medical and/or psychological conditions which enable substantial independence (e.g., the ability to live at home), but still require substantially continuous monitoring by the provider to insure well-being. These monitoring systems may be used by providers to obtain and analyze recent and/or real-time health data (e.g., user initiated distress indicator, blood pressure of an animal, body temperature of an animal, blood sugar level of an animal, vital statistics of an animal, room occupancy detection, internal air temperature at a location, external air temperature at a location, pulse of an animal, blood glucose level of an animal, blood oxygen level of an animal, emergency alerts, etc.) about an animal. Continuously gathering this health data enables appropriate and timely responses to dangerous conditions. However, the operation of these monitoring systems requires the installation, use and maintenance of any number of local sensors at the monitored area/service location (e.g., residence, office, building, campus, assisted living facility, etc.) and/or in substantial proximity to the animal(s) to be monitored. These local sensors may be expensive, difficult to install and calibrate, and limited as to the amount and/or breadth of data which can be sensed and communicated to the health monitoring system. Further, the physical locations and nature of these sensors may limit coverage, application, and use to certain segments/portions of the monitored area/service location, failing to provide a comprehensive view of the service location and/or health condition of the animal.

### BRIEF DESCRIPTION OF THE INVENTION

Systems for health care monitoring via monitoring of metered services are disclosed. In one embodiment, a health monitoring system for a service location is disclosed including: a utility meter communicatively connected to the service location; and at least one computing device communicatively connected to the utility meter, the at least one computing device adapted to monitor a health condition of an animal located at the service location by performing actions comprising: obtaining service consumption data about the service location from the utility meter; comparing the service consumption data with a pattern of service consumption for the service location; and determining a health condition of the animal based upon the comparison of the service consumption data with the pattern of service consumption for the service location.

A first aspect of the disclosure provides a health monitoring system for a service location includes: a utility meter communicatively connected to the service location; and at least one computing device communicatively connected to the utility meter, the at least one computing device adapted to monitor a health condition of an animal located at the service location by performing actions comprising: obtaining service consumption data about the service location from the utility meter; comparing the service consumption data with a pattern of service consumption for the service location; and determining a health condition of the animal based upon the comparison of the service consumption data with the pattern of service consumption for the service location.

A second aspect provides a program product stored on a computer readable medium, which when executed by at least one computing device, performs the following: obtains service consumption data from the utility meter about a service location; compares the service consumption data with a pattern of service consumption for the service location; and determines a health condition of an animal located at the service location based upon the comparison of the service consumption data with the pattern of service consumption for the service location.

A third aspect provides a utility meter including: a meter base adapted to be communicatively connected to a power source and a service location; and at least one computing device communicatively connected to the meter base, the at least one computing device adapted to monitor a health condition of an animal located at the service location by performing actions comprising: obtaining service consumption data about the service location; comparing the service consumption data with a pattern of service consumption for the service location; and determining a health condition of the animal based upon the comparison of the service consumption data with the pattern of service consumption for the service location.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic illustration of an environment including a health monitoring system in accordance with an embodiment of the invention;

FIG. 2 shows a schematic illustration of an environment including a health monitoring system in accordance with an embodiment of the invention;

FIG. 3 shows a method flow diagram illustrating a process according to embodiments of the invention.

FIG. 4 shows a schematic illustration of an environment including a health monitoring system in accordance with an embodiment of the invention.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated herein, aspects of the invention provide for systems configured to use utility service consumption data as part of a health monitoring system. These systems transmit service consumption data from a utility meter (e.g., an electrical meter, a water meter, a gas meter, a smart meter, a network of electrical meters, or any other form of meter configured to monitor utility service consumption at a location) to a health monitoring system which applies the service consumption data to health condition analysis for an at-risk animal (e.g., a human being, a patient, a person, etc.).

Some health monitoring systems use a plurality of local sensors disposed throughout a monitored area/service location (e.g., a residence) to monitor the well-being of an animal (e.g., a human being, a patient, a person, etc.). These local sensors may be expensive and difficult to install, limiting the area which may be effectively monitored. Further, these local sensors may be diagnostically limited, as each local sensor includes the capability to monitor only a few vital statistics of the animal to be monitored. Additionally, these local sensors may inadvertently obtain readings from animals other than the animal intended to be monitored, resulting in inaccurate readings, predictions and analysis. As a result, the comprehensiveness of coverage and the number of animals who may have access to health monitoring systems may be limited.

In contrast to these conventional systems, embodiments of the current invention provide for a health monitoring system which uses utility service consumption data (e.g., electrical consumption at the service location, gas consumption at the service location, etc.) to monitor the health of one or more animals at a service location. The health monitoring system is communicatively connected to a utility meter and obtains from the utility meter service consumption data for the service location (e.g., a residence, office, building, campus, assisted living facility, etc.). This service consumption data may be used to establish service consumption patterns and/or boundary conditions for service consumption at the service location across one or more periods of time (e.g., hourly, daily, weekly, seasonally, etc.). Further, the health monitoring system may monitor typical usage across days, weeks, etc. for designated periods of time (e.g., early morning, evening, mid-day, etc.). The health monitoring system may compare service consumption data obtained from the utility meter in real-time, with a set of developed or predetermined service consumption boundary conditions for the service location to determine a health condition of an animal located at the service location. The health monitoring system may further analyze a health condition of the animal by combining the determination based upon the service consumption data with health data (e.g., vital statistics, emergency alerts, etc.) gathered from a plurality of local sensors at the residence. The health monitoring system cross correlates and/or compares the health data and the service consumption data (e.g., an occupant in a bathroom but the hot water heater is not used/activated, an occupant is in the kitchen but appliances are not operated, a room/space heater is used excessively while a body temperature of an occupant is/remains low, factoring of outside ambient conditions into the expected consumption, etc.) to determine a health condition of the animal. The health monitoring system may then communicate the health condition of the animal to a utility company, a family member, a monitoring service, etc. via a communication system (e.g., cell phone, wired phone, text message, electronic mail, instant message or any other communication system known in the art).

As will be appreciated by one skilled in the art, the health monitoring system described herein may be embodied as one or more systems, methods or computer program products. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “network” or “system.” Furthermore, the present invention may take the form of a computer program product embodied in any tangible medium of expression having computer-usable program code embodied in the medium.

Any combination of one or more computer usable or computer readable medium(s) may be utilized. The computer-useable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

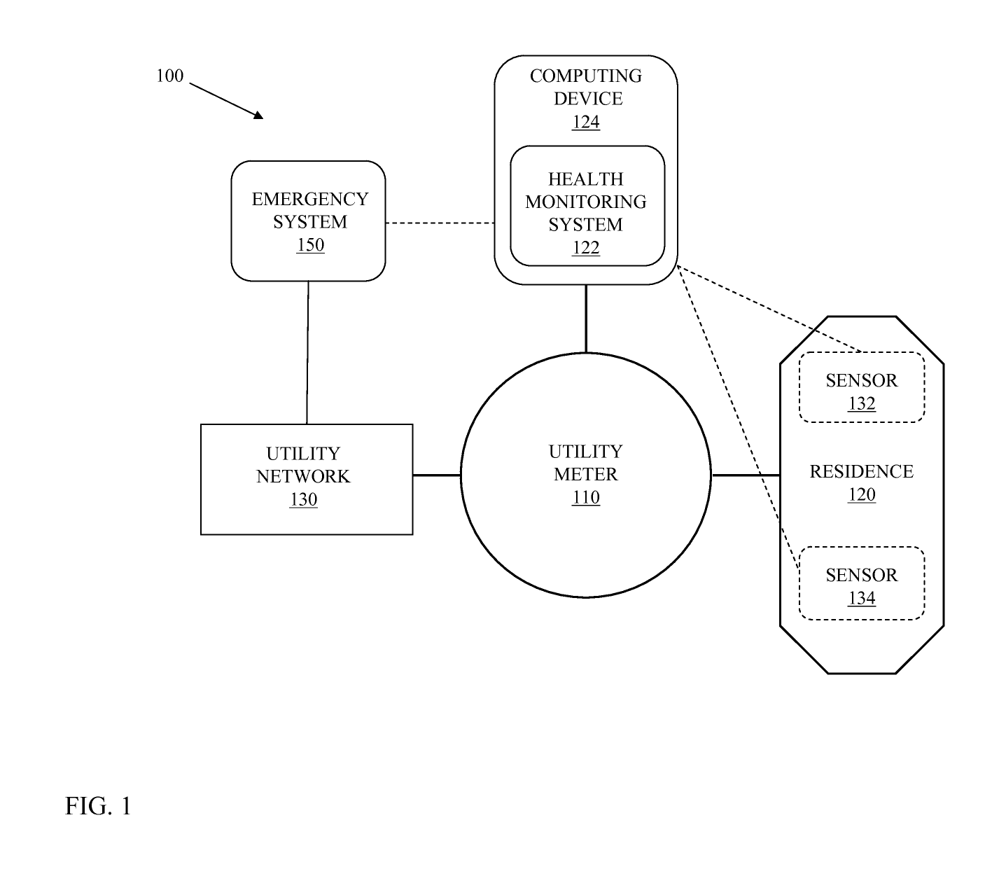

Turning to the Figures, embodiments of a health monitoring system are shown, where the health monitoring system may incorporate utility service consumption data from a utility meter into the health condition analysis of an animal (e.g., a human being, a patient, a person, etc.). Each of the components in the Figures may be connected via conventional means, e.g., via wireless mesh, WiFi, power line communication, cellular, and/or other known means as is indicated in the FIGS. 1-4. Specifically, referring to FIG. 1, a schematic illustration of an environment 100 including a health monitoring system 122 is shown according to embodiments of the invention. Environment 100 may include a utility meter 110 communicatively connected to a service location (e.g., residence 120) and a utility network 130. Utility meter 110 may include an electrical meter, a water meter, a gas meter, a smart meter, a network of electrical meters, or any other form of utility meter as is known in the art. In this embodiment of the invention, utility meter 110 monitors utility service consumption by residence 120. In one embodiment, utility meter 110 may serve as a secure communications link and relay communications between utility network 130 and residence 120, thereby providing utility network 130 with substantially real-time service consumption data for residence 120. In another embodiment, utility meter 110 may generate and transmit communications to utility network 130 and/or residence 120, these communications including service consumption data for residence 120. As is also shown in FIG. 1, environment 100 may include a computing device 124 communicatively connected to utility meter 110. Computing device 124 may include health monitoring system 122 which is configured to monitor a health condition of an animal (e.g., a human being, a patient, a person, etc.) at residence 120. In one embodiment, health monitoring system 122 may obtain service consumption data for residence 120 from utility meter 110 (e.g., via computing device 124). Health monitoring system 122 can then analyze this service consumption data to determine a health condition of an animal located at residence 120.

In an embodiment of the present invention, service consumption data may include real-time service consumption data. In another embodiment, service consumption data may include time-of-day service consumption data. In one embodiment, service consumption data may be time stamped and/or correlated by utility meter 110. In another embodiment, service consumption data may be time stamped and/or correlated by computing device 124. These time stamps may be determined by any method as is known in the art, including: network time protocol, WWVB time broadcast, a global positioning system, utility meter 110, computing device 124, etc. In one embodiment, time stamped consumption data is used as part of a health condition determination by health monitoring system 122. Health monitoring system 122 identifying and storing service consumption data values at different times of day so as to develop a consumption pattern for an animal at residence 120. This consumption pattern then being used by health monitoring system 122 to identify changes in a health condition of the animal located at residence 120 (e.g., if the animal is usually awake by a certain time in the morning, as indicated by increased service consumption, and the service consumption does not increase during that timeframe on a given day, then health monitoring system 122 may adjust the health condition of the animal).

In an embodiment of the present invention, health monitoring system 122 may monitor service consumption at residence 120 over a period of time in order to establish patterns of service consumption for residence 120. These patterns of service consumption at residence 120 may then be used to analyze real-time service consumption data values to determine a health condition of an animal located at residence 120. In one embodiment, real-time service consumption values at residence 120 may be cross-correlated and/or compared to developed service consumption patterns for residence 120 to analyze a health condition of an animal located at residence 120. In another embodiment, health monitoring system 122 may cross correlate identified patterns of service consumption at residence 120 with additional sensors or data sets (e.g., time of day, date, room occupancy, environmental conditions, etc.) to determine a health condition of an animal located at residence 120. In one embodiment, health monitoring system 122 uses these patterns of service consumption to continuously define and modify boundaries for service consumption specific to residence 120 (e.g., adjusting for the consumption pattern as a result of time of day or season). In one embodiment, these boundary conditions represent the minimum and maximum anticipated service consumption values for residence 120. In one embodiment, these boundary conditions may dynamically adjust based upon time of day, day of the week, time of year, occupancy, in response to a user override, etc. Health monitoring system 122 may be configured to compare recent or real-time service consumption data for residence 120 received from utility meter 110 with these boundary conditions to analyze the health condition of an animal at residence 120 based upon correlations or deviations from the boundaries or patterns of service consumption.

In one embodiment, health monitoring system 122 may include data representing a pre-programmed pattern of service consumption for residence 120. In one embodiment, this pre-programmed pattern of service consumption is time sensitive (e.g., if the smart meter does not detect a set amount of electricity consumption by a given time then the health status is adjusted). In another embodiment, the pre-programmed pattern is set by a utility service provider and/or health care provider, and establishes boundaries for service consumption values (e.g., amount of kilowatt hours consumed), which substantially define an allowable range of service consumption for residence 120. The allowable range conforming to previously identified patterns of use (e.g., real-time service consumption values which are consistent with service consumption values which were stored when the animal was in good health). In any event, if the service consumption data for residence 120 deviates beyond the boundary conditions (pre-programmed or developed consumption patterns), then a health condition indicator may be generated and/or transmitted by health monitoring system 122 via computing device 124. Computing device 124 may transmit the health condition indicator to third parties via phone (e.g., cell phone, wired phone, text message, etc.), internet (e.g., electronic mail, instant message, etc.), utility network 130, or any other communication system known in the art.

In one embodiment of the invention, computing device 124 may generate a service consumption alert configured to be communicated to an emergency system 150 through utility network 130 via utility meter 110. The service consumption alert indicates a service consumption deviation outside of the patterns of consumption or beyond the established boundary conditions of service consumption for residence 120. Emergency system 150 may include an emergency medical services team, a health care provider, or other emergency personnel as is known in the art. In another embodiment of the invention, computing device 124 and/or health monitoring system 122 may be integrated into utility meter 110 to transmit an indicator/alert to emergency system 150 through utility network 130. In another embodiment of the invention, computing device 124 may directly transmit the service consumption alert to emergency system 150.

In one embodiment, residence 120 may include a sensor 132 (shown in phantom) and a sensor 134 (shown in phantom) configured to monitor animal(s) at residence 120. It is understood that sensors 132 and 134 may comprise any known sensor (e.g., motion sensor, electrical meter, thermometer, blood sugar sensor, infrared occupancy detector, acoustic detector, etc.). In one embodiment, sensors 132 and 134 may comprise a network of electrical meters disposed about residence 120 and communicatively connected to utility meter 110 and/or computing device 124 via wireless, radio-frequency, power line communication, or any other known communication systems. Sensors 132 and 134 configured to obtain service consumption data for specific areas within residence 120, and communicate these service consumption data values to utility meter 110 and/or computing device 124. In any event, health monitoring system 122 may obtain health data from sensor 132 and/or sensor 134 via utility meter 110 and computing device 124. In another embodiment, (shown in phantom) computing device 124 may be directly communicatively connected to at least one of sensor 132 or sensor 134, health monitoring system 122 thereby obtaining health data from sensor 132 and/or sensor 134 directly via computing device 124. In one embodiment, health monitoring system 122 may analyze a health condition of an animal at residence 120 based upon health data obtained from sensor 132 and/or sensor 134. In one embodiment, health monitoring system 122 may determine a health condition of an animal at residence 120 by comparing health data obtained from sensor 132 and/or sensor 134 with a set of predetermined health data values. In another embodiment of the invention, health monitoring system 122 may analyze a health condition of an animal at residence 120 based upon service consumption data obtained from utility meter 110 and health data obtained from sensor 132 or sensor 134.

It is understood that as described herein, sensors 132 and 134 may include one or more conventional medical or other sensor devices including but not limited to: a vital signs monitor, an electrical meter, an activity monitor, a metered medication delivery device, a medication storage system, a communication device, a blood treatment device, a smart meter, an oxygen concentrator, a feeder device, a power management unit, an intelligent electronic device, a programmable communicating thermostat, an air conditioning system, and a heating system.

In any event, computing device 124 can comprise any general purpose computing article of manufacture capable of executing computer program code installed by a user (e.g., a personal computer, server, handheld device, etc.). However, it is understood that computing device 124, utility meter 110 and sensors 132 and 134 are only representative of various possible equivalent computing devices that may perform the various process steps of the disclosure. To this extent, in other embodiments, computing device 124 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

As previously mentioned and discussed further below, health monitoring system 122, has the technical effect of enabling computing device 124 to perform, among other things, the monitoring, analysis and/or notification functions described herein. It is understood that some of the various components shown in FIGS. 1-4 can be implemented independently, combined, and/or stored in memory for one or more separate computing devices that are included in computing device 124. Further, it is understood that some of the components and/or functionality may not be implemented, or additional schemas and/or functionality may be included as part of health monitoring system 122. The health monitoring system of the present disclosure is not limited to any one particular meter, electrical meter, smart meter, network or other system, and may be used with other power and communication systems. Additionally, the health monitoring system of the present invention may be used with other systems not described herein that may benefit from the accurate, secure, real-time health condition and data communications link provided by the health monitoring system described herein.

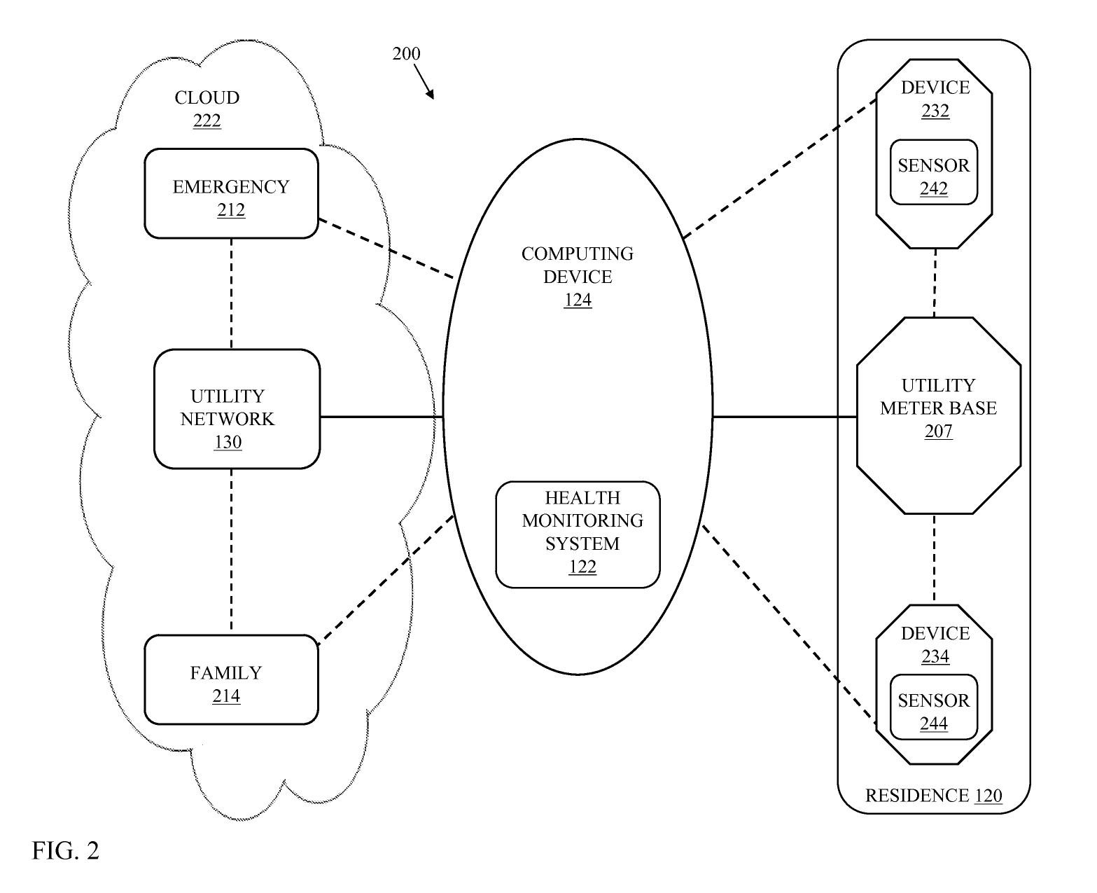

Turning to FIG. 2, a schematic illustration of an environment 200 including a health monitoring system 122 is shown according to an embodiment of the invention. It is understood that elements similarly numbered between FIG. 1 and FIG. 2 may be substantially similar as described with reference to FIG. 1. Redundant explanation of these elements has been omitted for clarity. Returning to FIG. 2, in this embodiment, health monitoring system 122 may be communicatively connected to a utility meter base 207, a device 232 and a device 234 via a computing device 124. Devices 232 and 234 may include a sensor 242 and a sensor 244 configured to obtain health data about an animal located at residence 120. In one embodiment, devices 232 and 234 may communicate health data directly to computing device 124. In this embodiment, devices 232 and 234 deliver communications including health data to utility meter base 207 which securely relays the communications including health data to health monitoring system 122 via computing device 124. In one embodiment, devices 232 and 234 may communicate health data to utility meter base 207 independently or cumulatively. In one embodiment, health monitoring system 122 may obtain health data and/or service consumption data from utility meter base 207, analyze the health data and/or service consumption data, generate a health condition indicator and transmit the health condition indicator to a cloud 222 via computing device 124. Cloud 222 may include a utility network 130, an emergency network 212 for initiating and prioritizing emergency responses and a family network 214 for notifying family members of an animal at residence 120 who may be in need of assistance. In one embodiment of the invention, computing device 124 may communicate a service consumption alert to one or more of emergency network 212 and family network 214. In another embodiment of the invention, computing device 124 may transmit a health condition indicator directly to either or both of emergency network 212 and family network 214.

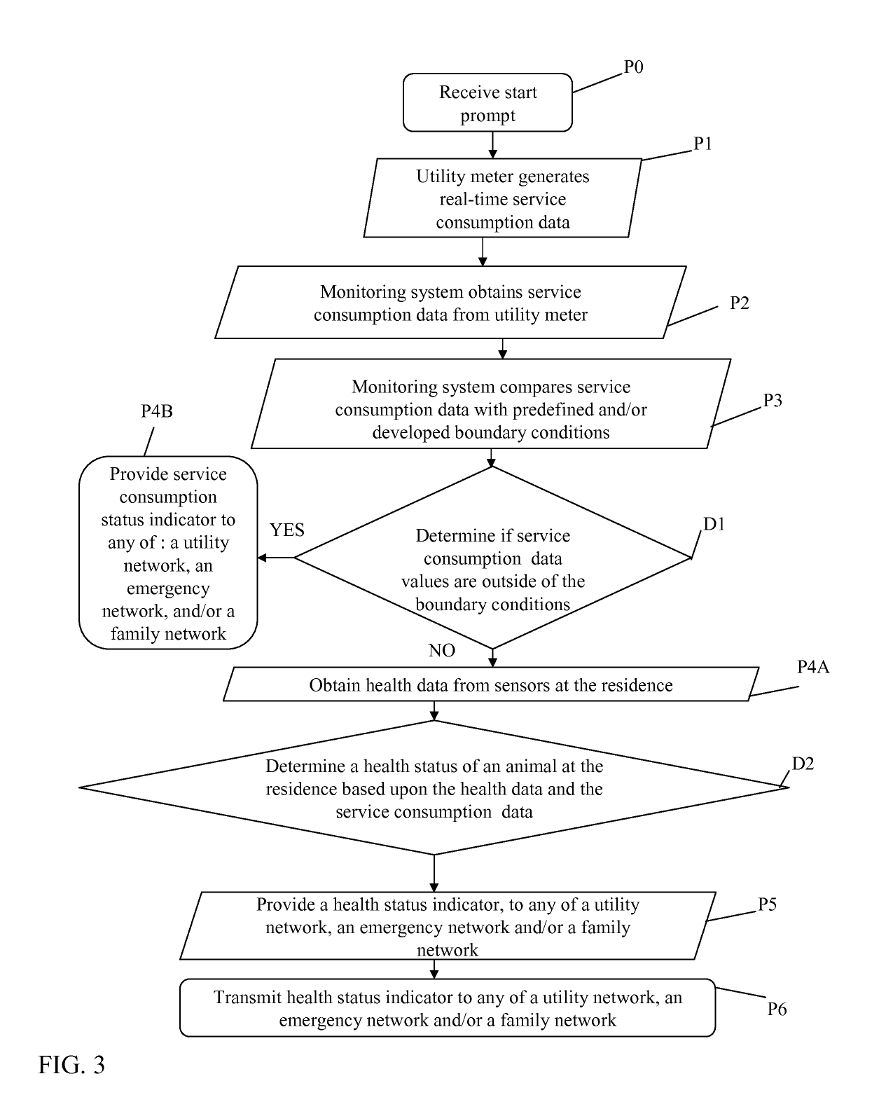

Turning to FIG. 3, an illustrative method flow diagram is shown according to embodiments of the invention: In pre-process P0, computing device 124 receives a scheduled or user-prompted start indicator to begin monitoring a health condition of an animal at residence 120. That is, either a scheduled analysis or a user-commanded analysis may be performed by computing device 124 on residence 120 in response to a prompt to determine a health condition of an animal at residence 120. Following pre-process P0, in process P1, utility meter 110 generates real-time service consumption data for residence 120. Following process P1, in process P2, health monitoring system 122 obtains service consumption data from utility meter 110. That is, computing device 124 receives recent or real-time service consumption data for residence 120 from utility meter 110. Following process P2, in process P3, health monitoring system 122 cross correlates and/or compares the obtained service consumption data for residence 120 with the pre-defined or developed patterns of service consumption (e.g., service consumption as a function of time of day, service consumption as a function of day of the week, etc.) or boundary conditions for service consumption at residence 120. In one embodiment, the patterns of service consumption and/or boundary conditions may be pre-set and or established by a health care provider, utility service provider etc. In another embodiment, the patterns of service consumption and/or boundary conditions may be established by health monitoring system 122, the patterns of service consumption and boundary conditions developed by health monitoring system 122 based upon previously received service consumption data for residence 120.

Following process P3, in decision D1, health monitoring system 122 determines if the values of obtained service consumption data from utility meter 110 deviate from the patterns of service consumption and/or established boundary conditions for residence 120. After decision D1, if values for the service consumption data are determined to deviate from the patterns for service consumption and/or the boundary conditions for residence 120, then at process P4B, computing device 124 provides a service consumption indicator to any of a utility network, an emergency network, and/or a family network. The service consumption indicator alerts any of the networks to irregular utility service consumption at residence 120. However, if after performing decision D1, health monitoring system 122 determines that values for the service consumption data do not deviate from the patterns for service consumption and/or the boundary conditions, then in process P4A, health monitoring system 122 may obtain health data from sensors at residence 120 via computing device 124, this health data including but not limited to a user initiated distress indicator, blood pressure indicator, temperature indicator, blood sugar level indicator, vital statistics indicator, pulse indicator, blood glucose level indicator, blood oxygen level indicator, emergency alerts indicator, etc. That is, computing device 124 may obtain health data from the sensors via utility meter 110 and/or directly from the sensors.

Following process P4A, in decision D2, health monitoring system 122 determines a health condition of an animal at residence 120 based upon the health data and the service consumption data obtained from utility meter 110. In one embodiment, the health monitoring system 122 may scan the health data and the service consumption data in search of pre-defined critical values and correlations (e.g., excessively fast or slow heartbeat, decreased body temperature, low blood sugar, fluctuating service consumption, decreased body temperature and increased space heater service consumption, prolonged occupancy of a room with little to no service consumption, etc.). In one embodiment, health monitoring system 122 may use both the health data and the service consumption data to determine a comprehensive health condition of an animal at residence 120. In one embodiment, health monitoring system 122 cross correlates the health data and the service consumption data to determine a comprehensive health condition of the animal. In one embodiment, health monitoring system 122 may adjust a health status/condition of an animal at residence 120 by determining that the animal has entered a bathroom at residence 120 but that the hot water heater has not been used/activated. In another embodiment, health monitoring system 122 may adjust expected consumption rates of appliances at residence 120 based upon outside ambient conditions (e.g., excessive heat or cold enabling adjustment of the expected consumption rates in anticipation of the operation of heaters or air conditioners). In another embodiment, health monitoring system 122 may adjust a health status based upon an animal entering the kitchen at residence 120 but not operating any appliances. In another embodiment, health monitoring system 120 may adjust a health status by determining that an animal has a low body temperature and that a room/space heater at residence 120 is being used excessively. In any event, following decision D2, in process P5, computing device 124 may provide a health condition indicator to any of a utility network, an emergency network, utility meter 110, an In-Home Display (IHD), a mobile device, an e-mail account, an audible alarm, another health monitoring system, and/or a family network, etc. The health condition indicator is based upon the health data and/or the service consumption data and represents a health condition of an animal at residence 120. Following process P5, in process P6, computing device 124 transmits the health condition indicator to any of a utility network 130, an emergency network 212, and/or a family network 214. In one embodiment, computing device transmits the health condition indicator via utility meter 110 and cloud 222. In another embodiment, computing device 124 may directly transmit the health condition indicator to any of utility network 130, emergency network 212, and/or family network 214 via phone (e.g., cell phone, wired phone, text message, etc.), internet (e.g., electronic mail, instant message, etc.), utility network 130, or any other communication system known in the art.

The data flow diagram and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

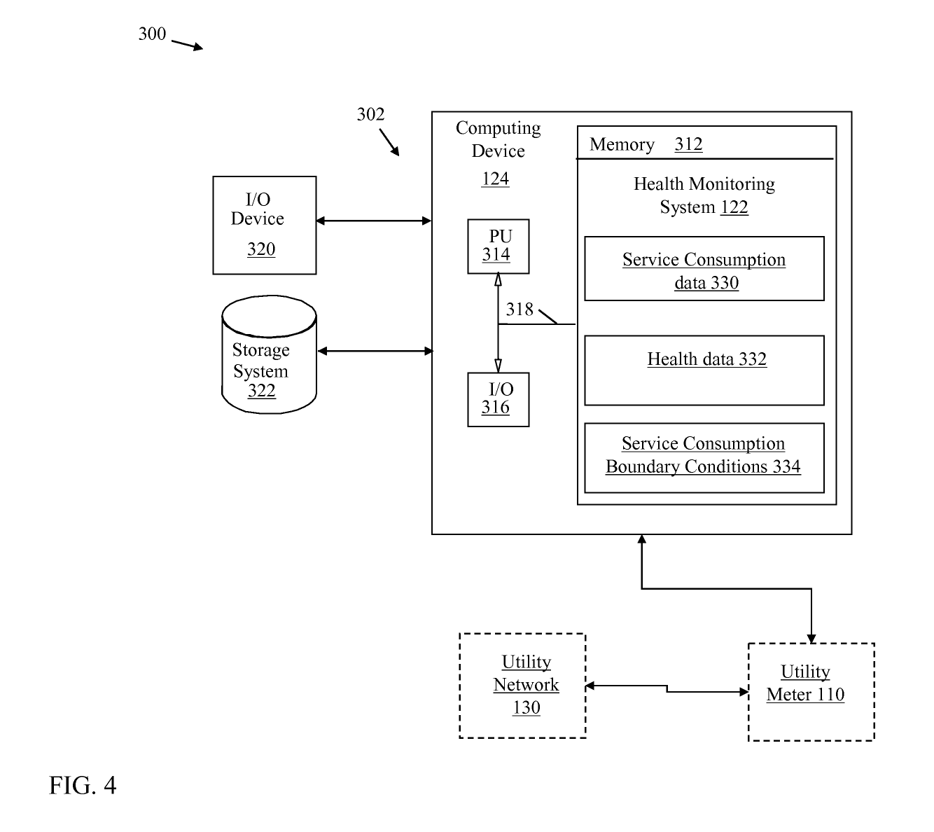

Turning to FIG. 4, an illustrative environment 300 including a health monitoring system 122 is shown according to embodiments of the invention. Environment 300 includes a computer infrastructure 302 that can perform the various processes described herein. In particular, computer infrastructure 302 is shown including computing device 124 which includes health monitoring system 122.

Computing device 124 is shown including a memory 312, a processor (PU) 314, an input/output (I/O) interface 316, and a bus 318. Further, computing device 124 is shown in communication with an external I/O device/resource 320 and a storage system 322. As is known in the art, in general, processor 314 executes computer program code, such as health monitoring system 122, that is stored in memory 312 and/or storage system 322. While executing computer program code, processor 314 can read and/or write data, such as service consumption data 330, health data 332, and/or service consumption boundary conditions 334, to/from memory 312, storage system 322, and/or I/O interface 316. Bus 318 provides a communications link between each of the components in computing device 124. I/O device 320 can comprise any device that enables a user to interact with computing device 124 or any device that enables computing device 124 to communicate with one or more other computing devices. Input/output devices (including but not limited to keyboards, displays, pointing devices, etc.) can be coupled to the system either directly or through intervening I/O controllers.

In some embodiments, as shown in FIG. 4, environment 300 may optionally include utility meter 110 and utility network 130 communicatively connected to health monitoring system 122 through computing device 124 (e.g., via wireless or hard-wired means). In some embodiments, computing device 124 and/or health monitoring system 122 may be disposed upon or within utility meter 110.

As discussed herein, various systems and components are described as “obtaining” data (e.g., service consumption data, temperatures, dependency data, health condition, etc.). It is understood that the corresponding data can be obtained using any solution. For example, the corresponding system/component can generate and/or be used to generate the data, retrieve the data from one or more data stores or sensors (e.g., a database), receive the data from another system/component, and/or the like. When the data is not generated by the particular system/component, it is understood that another system/component can be implemented apart from the system/component shown, which generates the data and provides it to the system/component and/or stores the data for access by the system/component.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A health monitoring system for a service location, the health monitoring system comprising:
a utility meter communicatively connected to the service location; and
at least one computing device communicatively connected to the utility meter, the at least one computing device adapted to monitor a health condition of an animal located at the service location by performing actions comprising:
obtaining service consumption data about the service location from the utility meter;
comparing the service consumption data with a pattern of service consumption for the service location; and
determining a health condition of the animal based upon the comparison of the service consumption data with the pattern of service consumption for the service location.

2. The health monitoring system of claim 1, further comprising a set of sensors communicatively connected to the service location and communicatively connected to the at least one computing device, the set of sensors adapted to obtain health data about the animal.

3. The health monitoring system of claim 2, wherein the determining of the health condition of the animal further includes:
obtaining health data for the animal from the set of sensors;
comparing the health data with a set of predetermined health data values; and
determining a comprehensive health condition of the animal based upon a comparison of the service consumption data and the health data.

4. The health monitoring system of claim 1, wherein the at least one computing device is further adapted to provide to the utility meter a health condition indicator, the health condition indicator including the health condition of the animal located at the service location.

5. The health monitoring system of claim 4, wherein the health condition indicator is transmitted via the utility meter to at least one of: a utility network, a family network, an In-Home Display (IHD), a mobile device, an e-mail account, an audible alarm, or an emergency network.

6. The health monitoring system of claim 1, wherein the at least one computing device includes a utility meter processor.

7. The health monitoring system of claim 1, wherein the at least one computing device is adapted to store the service consumption data and generate a set of service consumption boundary conditions for the service location based upon the stored service consumption data.

8. A program product stored on a computer readable medium, which when executed by at least one computing device disposed upon a utility meter, performs the following:
obtains service consumption data from the utility meter about a service location;
compares the service consumption data with a pattern of service consumption for the service location; and
determines a health condition of an animal located at the service location based upon the comparison of the service consumption data with the pattern of service consumption for the service location.

9. The program product of claim 8, wherein the determining the health condition for the animal located at the service location further includes:
obtaining health data for the animal from a set of sensors operably connected to the service location and communicatively connected to the at least one computing device;
comparing the health data with a set of predetermined health data values; and
determining a comprehensive health condition of the animal based upon a cross correlation of the service consumption data and the health data.

10. The program product of claim 8, wherein the determining the health condition for the animal located at the service location further includes providing to the utility meter a health condition indicator, the health condition indicator including the health condition of the animal located at the service location.

11. The program product of claim 10, wherein the health condition indicator is transmitted via the utility meter to at least one of: a utility network, a family network, an In-Home Display (IHD), a mobile device, an e-mail account, an audible alarm, or an emergency network.

12. The program product of claim 8, wherein the at least one computing device includes a utility meter processor.

13. The program product of claim 8, wherein the at least one computing device is further adapted to store the service consumption data and generate a pattern of service consumption for the service location based upon the stored service consumption data.

14. The program product of claim 13, wherein the analyzing the service consumption data further includes:
comparing the service consumption data with the generated pattern of service consumption for the service location; and
providing to the utility meter a service consumption condition indicator, the service consumption condition indicator including a service consumption condition of the animal located at the service location.

15. A utility meter comprising:
a meter base adapted to be communicatively connected to a power source and a service location; and
at least one computing device communicatively connected to the meter base, the at least one computing device adapted to monitor a health condition of an animal located at the service location by performing actions comprising:
obtaining service consumption data about the service location;
comparing the service consumption data with a pattern of service consumption for the service location; and
determining a health condition of the animal based upon the comparison of the service consumption data with the pattern of service consumption for the service location.

16. The utility meter of claim 15, further comprising a set of sensors operably connected to the service location and communicatively connected to the at least one computing device, the set of sensors adapted to obtain health data about the animal.

17. The utility meter of claim 15, wherein the determining of the health condition for the animal located at the service location further includes:
obtaining health data for the animal from the set of sensors;
determining a comprehensive health condition of the animal based upon a cross correlation of the service consumption data and the health data.

18. The utility meter of claim 15, wherein the at least one computing device is further adapted to provide to the meter base a health condition indicator, the health condition indicator including the health condition of the animal located at the service location.

19. The utility meter of claim 15, wherein the at least one computing device includes a utility meter processor.

20. The utility meter of claim 15, wherein the at least one computing device is adapted to store the service consumption data and generate a set of service consumption boundary conditions for the service location based upon the stored service consumption data.
